(19) United States
(12) Patent Application Publication
(10) Pub. No.: US 2015/0044389 A1
(43) Pub. Date: Feb. 12, 2015

(54) Process for the Realization of Decorations

(71) Applicant: Ferdiam S.r.I., GREZZANA (Verona) (IT)

(72) Inventors: Alberto FERRARI, GREZZANA (Verona) (IT); Isidoro FERRARI, GREZZANA (Verona) (IT)

(73) Assignee: FERDIAM S.R.L., GREZZANA (Verona) (IT)

(21) Appl. No.: 14/452,031

(22) Filed: Aug. 5, 2014

(30) Foreign Application Priority Data
Aug. 12, 2013 (IT) VR2013A000199
May 8, 2014 (IT) VR2014A000124

(51) Int. Cl. B44C 1/00; B05D 3/06; B05D 1/00; B05D 5/00

(52) U.S. Cl. CPC B44C 1/00; B05D 5/00; B05D 3/065; B05D 1/00
USPC 427/558; 427/202

(57) ABSTRACT

It refers to a process for the realization of decorative items by utilizing granules of precious and/or semiprecious, natural and/or synthetic stones, to be applied on a support.

The present invention refers, in general, to a process for the realization of decorations. More particularly, it refers to a process for the realization of items decorated by utilizing precious and/or semiprecious, natural and/or synthetic stones.

According to prior art, for the realization of articles of jewelry and, more in general, for the realization of products decorated, in case precious and/or semiprecious stones are utilized, the stones are usually fixed to a support by setting.

The setting of a stone is possible if the size of the stone is larger than about 0.8 mm. Consequently, the granules of precious and/or semiprecious stones having a particle size less than such size are difficult to be utilized although such granules have an interesting cost/weight ratio owing to their difficulty of use.

An aim of the present invention is to remove the above mentioned problems and others by implementing a process for the realization of decorations utilizing precious and/or semiprecious, natural and/or synthetic stones difficult to be set.

Another aim of the invention is to make precious and/semiprecious stones having a particle size less than 0.8 mm usable.

Another aim of the invention is to implement a process for the realization of decorations that is rapid and practical to be carried out.

Another aim of the invention is to implement a process that allows to obtain an item decorated with stone granules, pleasant from an aesthetic point of view.

Another aim of the invention is to ensure a high mechanical strength to the surface of the decoration so that it is difficult for external agents to easily scratch the surface of the decoration.

Another aim of the invention is to give a strong protection to the decoration.

Another aim of the invention is to ensure a greater adhesion of the precious stones to the support so that the resistance to high temperatures increases and at the same time, the surface has a strong friction coefficient.

Another aim of the invention is to create tridimensional decorations and not only flat decorations.

Another aim of the invention is to realize decorations in which the reflections of the granules of stones are enhanced as much as possible.

Another aim of the invention is to realize decorations that may be utilized also as instruments against counterfeiting and/or as means for the logistic management of the product on which the decorations may be applied.

The above mentioned aims and others are achieved according to the invention through a process for the realization of decorations by utilizing at least one typology of granules of precious and/or semiprecious, natural and/or synthetic stones, to be fixed to a surface of a support.

In particular, the method is characterized by the fact of comprising the following phases:
making at least one portion of surface of the support adhesive;
distributing one typology of stone granules on the surface of the support;
pressing the stone granules on the surface of the support so that the stone granules adhere to the portion of surface made adhesive;
recovering the stone granules that have not adhered to the portion of surface made adhesive.

Through this process it is possible to join the stone granules to a support without the need of setting and consequently, without limitations due to the particle size of the stones.

For making the surface portion of the support adhesive it is possible to apply a glue or a layer of a bi-adhesive. In particular, the glue may be at an initial high adhesiveness and resistant to the contact with a solution of sodium hydroxide, at 1% in water, for at least 15 minutes.

Advantageously, for making at least one surface portion of the support adhesive, the following phases are comprised:
spraying a photosensitive lacquer on the support surface, made adhesive previously, so as to make the support surface no more adhesive;
exposing the at least one surface portion of the support to UV rays so as to sensitize only the lacquer distributed on the at least one surface portion;
removing the lacquer previously sensitized so as to make only the at least one surface portion of the support, exposed to UV rays, adhesive again.

Through this process, it is possible to apply an adhesive or a glue on the entire support surface, to successively cover the entire adhesive surface and to successively uncover and make adhesive only the portions interested. This operation results to be more easily manageable than applying the glue only on the sectors interested; in particular, this process allows to have adhesive portions of any shape and well-defined profiles.

Besides, according to the process of the invention, the sensitization of the lacquer distributed on the surface portion of the support takes place according to the following phases:
superimposing a mask having at least one transparent area and at least one non-transparent area on the support surface;
exposing the support surface covered by the mask to UV rays so that only the lacquer of the one or more surface portions of the support corresponding to the one or more transparent areas of the mask is sensitized.

Through the utilization of the mask, the one or more portions to be made adhesive are defined precisely and without shape limitation.

Alternatively, the sensitization of the lacquer distributed on the surface portion of the support may take place by means of a laser beam directed by an optical system on said surface portion, with extreme ease and accuracy.

Advantageously, the removal of the sensitized lacquer may take place by immersing the support surface in a developing solution but without removing also the glue.

In order to make the applying of the stone granules more comfortable, after the support has been immersed in the developing solution, the support may be rinsed in water and dried.

In particular, the developing solution may be prepared with a solution containing sodium hydroxide in a quantity between 0.5% and 2% by weight.

Advantageously, the support may be decorated with different typologies of stones so as to define different areas on the support surface for the application of stone granules. In fact, the phases of making at least one surface portion of the support adhesive, distributing one typology of stone granules on the support surface, pressing the stone granules on the support surface so that the stone granules adhere to the at least one surface portion, may be effected more times with always different typologies of stone granules to obtain a surface decorated with stones of different typology.

In order to strengthen the article decorated and protect the surfaces adorned with the stones, the process according to the invention may provide that the decorated support surface is covered with a layer of transparent resin.

The process according to the invention may provide that after joining the granules of stones to the support so as to realize an initial decoration, the following phases are comprised:
placing the initial decoration in the inside of a template having perimeter dimensions equal to those of the initial decoration itself so is that the granules of stones of the initial decoration are facing upwards with respect to the initial support;
pouring a hardening substance, for instance a resin, in the liquid state inside the room defined by the template, on the granules of stones of the initial decoration;
making the hardening substance hard so that the granules of stones of the initial decoration fix to it;
when the hardening substance has become hard, removing the template from the manufactured article so far obtained;
removing the initial support and the adhesive substance from the manufactured article obtained so as to obtain the final decoration whose surface is provided with the granules of stone.

Through this process it is possible to join granules of stones to a support without the need of setting them and consequently, without limitations due to the particle size of the stones.

Furthermore, the decoration will be applicable also on objects that frequently come in contact with other surfaces and that, otherwise, will risk to damage the decoration, such as articles of clothing or inserts in a tile.

In addition, the so-obtained final product will have a substantially flat surface resulting in a pleasant feel to the touch.

Advantageously, in order to improve the surface effect of the granules of stones, after the initial support has been removed from the manufactured article obtained, possible residues of adhesive substance remained on the granules of the final decoration can be removed.

Besides, the granules of stones present on the surface of the final decoration are cleaned with a detergent or by sandblasting in order to remove possible more superficial residues of resin and to improve the reflectance of the granules of stones arranged on the surface.

Advantageously, before pouring the resin in the inside of the template, the initial decoration placed in the template may be covered evenly with precious stones of a very fine grain so that the lines and shapes drawn on the initial support are no more visible. In this way, the aesthetic effect of the final decoration is improved.

Moreover, once the initial decoration has been placed in the template, it is possible to pour a first layer of resin without filling the template completely. A total filling of the template is rather obtained by using metal powders and/or sintered polymer powders so as to obtain a different lower support of the final decoration according to the need of use of the decoration.

For enhancing the reflections of the stone granules that will be arranged on the visible surface of the final decoration, photo-luminescent and/or fluorescent pigments may be mixed in the hardening substance used.

These pigments may be distributed according to a percentage concentration between 0.5 and 10, more specifically between 2 and 5, so as to obtain a good compromise between the component ensuring the union with the granules of stones and the component enhancing the reflections of the granules.

Advantageously, a data storage and transmission device, such as a Rfid or NFC transponder may be embedded in the hardening substance to communicate, to suitable readers, data relevant to the decoration or to the product on which the decoration is fixed.

In this way, the final decoration may be utilized for the tracking of the product along the production and distribution chain and to indicate the authenticity of the product on which the decoration is applied so as to act as an instrument against counterfeiting.

Further features and details of the invention will be better understood from the following description supplied as a non-limiting example.

A process according to a first implementing procedure of the invention allows to obtain an article decorated with one typology of granules of precious and/or semiprecious, natural and/or synthetic stones.

At first, a suitable support is made adhesive by directly applying glue or a layer of a bi-adhesive substance.

The support may be a metal plate or a stone slab, or a sheet or other element made of a plastic material depending on the final requirements of utilization and application of the article decorated.

Also the size of the support may be different depending on the application of the article decorated. For instance, in case the support may be inscribed in a square, the length of a side of this square may be included between 5 and 200 mm. but a greater or smaller size is not excluded in the specific case.

The adhesive material may be a glue having a high initial adhesion, for instance the glue M103 having a rubber base, and resistant to the contact for at least 15 minutes with a solution of sodium hydroxide at 1% in water.

Then, the process according to the invention provides that in a darkened room, the adhesive part of the support, made properly adhesive, is sprayed with a lacquer photosensitive to UVA light, for instance Positiv20®, and one or more layers of lacquer are created so as to make the previously adhesive surface no more adhesive.

A mask having transparent areas and black areas is superimposed on the surface interested by the one or more lacquer layers and the whole is exposed to UVA rays for about 10 min. In this way, the transparent areas allow UV rays to pass so that the UV rays sensitize the lacquer on the support in correspondence of such areas.

The lacquer sensitized by the UV rays, present in the predetermined areas, is removed by immersing the support in a developing solution, for instance a solution with sodium hydroxide between 0.5% and 2% by weight, for about 10 minutes.

Then, the support is rinsed with water and allowed to dry.

The areas where the lacquer has been removed are adhesive again and a layer of decorative stone granules is distributed on these areas, the granules being fixed on the glue layer as a result of the pressure exerted by a pad or by the fingers.

The surface of the gluing areas is totally interested by the granules fixed on it; the granules that have not adhered and are, therefore, in excess are recovered for subsequent applications.

The decorative granules of precious and/or semiprecious, natural and/or synthetic stones have dimensions that are preferably included between 0.1 and 0.8 mm. The dimensions are preferably selected in narrow particle size curves.

A second implementing procedure of the invention provides the utilization of two or more typologies of granules of precious and/or semiprecious, natural and/or synthetic stones, so as to create an article with areas covered with different stones.

According to this process, after the union of a first typology of stones with the support as described previously, it is possible to proceed with the photosensitization of the areas that are still covered by the photosensitive lacquer.

In case it is necessary to proceed with the gluing of the second typology of stones on specific areas, at first it is necessary to proceed with the utilization of a second mask having transparent areas and black areas so that the transparent areas correspond to the surface sectors of the support to be make adhesive again.

After the immersion of the support in a developing solution similar to that described previously, it is necessary to perform a rinsing with water and a subsequent drying of the support.

A layer of decorative granules of stones of different typology in comparison with that of the stones distributed previously is distributed on the areas made adhesive again. The stones of different typology are also fixed on the adhesive areas with a pressure exerted by a pad or with the fingers.

Also in this case, the part in excess, not glued, is recovered for subsequent applications, for instance by rotating the support of 90° and over.

In this way, the support is decorated with two different typologies of stones that are glued on different well-defined areas.

In case the transparent areas of the first mask and the transparent areas of the second mask do not interest the entire surface of the support, the support itself may be still decorated with another different typology of stones which will be glued on areas that have not been exposed yet to UV rays according to the implementing procedure described previously.

According to a third implementing procedure for the process of the invention, if after the application of a first typology of stones, a second typology of stones has to be applied on the entire remaining surface of the support, it is possible to proceed with the sensitization to UV of the entire support without using masks with transparent areas and black areas.

According to another implementing procedure of the process of the invention, instead of utilizing a lacquer photosensitive to the UVA light, to be sprayed on the support, a film photosensitive to UV rays and of a negative type is used.

More particularly, a suitable support is at first made adhesive by directly applying glue or a bi-adhesive layer. Later, the photosensitive, negative film is applied in a darkened room so that the support surface is made non-adhesive.

A mask with transparent portions and black portions, arranged according to an image to be formed on the support, is superimposed to the support and exposed to the UVA rays for about 10 minutes.

The transparent areas allow UV rays to pass so that the UV rays sensitize the photosensitive film and make it insoluble to a developing solution as described below.

In fact, the so-obtained article is immersed in a developing solution, similar to that described previously: while the photosensitive film portions, sensitized by the UV rays, are insoluble and keep the underlying adhesive layer covered, the film areas that are not sensitized by the UV rays—because hidden by the black portions of the mask—are removed by means of the same developing solution.

The support remains in the developing solution for about 10 minutes and is then rinsed with water and allowed to dry.

Then, as has been done for the implementing procedures described previously, a thick layer of decorative granules is distributed on the support portions from which the photosensitive film has been removed so that these portions are adhesive again. Then, the granules are fixed to the layer of glue by applying a pressure by means of a pad or fingers. The excess part that has not glued is recovered for the subsequent applications.

Then, the film sensitized to UV is removed by means of a removal solution properly prepared to remove the film portions exposed to UV.

The support is again rinsed with water and allowed to dry.

Now, also the other support portions not covered by the decorative granules are adhesive again and a thick layer of decorative granules is distributed on such portions, these granules being of a different typology in comparison with the granules that were already fixed, for instance as concerns the color. These granules are thus fixed to the adhesive layer by applying a pressure by means of a pad or fingers. Also in this case, the granules in excess that have not glued are recovered for subsequent applications.

The article decorated according to one of the procedures described previously may be protected and strengthened by applying a layer of protective transparent resin, such as an acrylic resin or a vinyl resin or a silicone resin.

The figures formed on the support by utilizing one or more typologies of granules of stones may have different shapes according to the requirements of the final user. The shape of the areas interested by the granules of stones corresponds obviously to the transparent areas and non-transparent areas of the utilized masks that may have the most different shapes, for instance the shape of animals, famous people, objects or other fanciful and abstract shapes.

Moreover, the precious and/or semiprecious, natural and/or synthetic stones utilized to be applied on the support according to the implementing procedures described previously may be covered with noble metals, in particular alloys of gold and platinum and diamond (black) according to the coating technique “Physical Vapor Deposition”, called commonly with the acronym PDV, or other similar techniques such as the electroplating.

The PDV technique or other similar technique may be utilized to cover almost perfectly octahedral and brilliant granules with synthetic diamond, gold or other precious alloys so as to obtain a pleasant and prestigious appearance.

In particular, the diamond coating according to the PDV technique may be utilized to obtain a black surface.

As an alternative to the use of a mask having black areas and transparent areas to select the surface portions of the support on which it is possible to photosensitize the lacquer by means of UVA rays, a laser ray may be utilized and properly directed by a digital control optical system on the same surface portions of the support concerned.

After obtaining an initial decoration comprising granules of precious and/or semiprecious, natural and/or synthetic stones, joined to an initial support by gluing or other technique according to one of the above-mentioned procedures or according to a different procedure, it is possible to proceed with the strengthening of the decoration as described below.

The decoration so far obtained is placed within a template having perimeter dimensions equal to the decoration itself. The depth of the template may vary according to the thickness to be obtained for the final product, once the implementing and strengthening process has finished.

In particular, the initial decoration is placed in the template so that the surface covered with the granules of stones is facing upwards.

Then, a resin compound in the liquid state is prepared and is poured carefully into the space created between the template and the decoration until the resin arrives at the level of the edge of the template. Thus, the resin is in contact with the granules of stones present in the initial decoration.

Then, the resin is made to harden by heating the resin according to the specifications of heat and time as required for the hardening of the resin.

Once the resin has hardened, the granules of precious and/or semiprecious, natural and/or synthetic stones do not adhere any longer to the initial adhesive support but the granules adhere to the resin. It is necessary, therefore, to detach the template used from the so-obtained product and the adhesive support, used initially, is removed by utilizing a suitable solvent. Any residual glue, left on the granules, is cleaned.

Finally, to remove any remaining superficial resin and improve the reflectance of the granules of stones placed on the surface it is necessary to clean the surface with special cleaning agents or by sandblasting.

To improve the surface yield it is possible to evenly coat the initial decoration placed in the template with precious stones of a very fine grain so that the lines and the shapes drawn on the initial support are no more visible.

Furthermore, according to a variant of the invention, once the initial decoration has been placed in the template, after pouring a first layer of resin, it is possible to obtain a complete filling of the template to the level of the surface by using metal powders or sintered polymer powders.

Also photo-luminescent and/or fluorescent pigments may be mixed with the resin in order to enhance the reflections of the granules of precious and/or semiprecious, natural and/or synthetic stones that will be arranged on the visible surface of the so-obtained final decoration.

In particular, the photo-luminescent and/or fluorescent pigments are present at a percentage concentration between 0.5 and 10, more specifically between 2 and 5.

Besides, according to another variant of the invention, a data storage and transmission device, such as a transponder operating on the base of the technology Rfid (Radio Frequency Identification, namely “Identification with a Radio Frequency”) or NFC (Near Field Communication, namely “Communication in proximity”) may be embedded in the resin or other substance utilized for the union of the granules of stones.

The presence of this device allows that the so-obtained final decoration may communicate, to proper readers, data regarding the decoration itself or the product on which the decoration is fixed.

In this way, the final decoration may be utilized to denote the authenticity of the product on which the decoration is applied and may also act as an instrument against counterfeiting.

In the same way, through the device embedded here, the decoration may be utilized for the tracking of the product on which the decoration is applied, along the production and distribution chain so as to make easy the logistics operations of a firm.

A technician of the sector may provide changes or variants that are to be considered as included in the scope of protection of the present invention. For instance, instead of the resin, also other substances may be utilized that are adapted to become hard and keep the granules of stones, previously united to the initial support, fixed firmly to such substances.

1. Process for the realization of decorations by utilizing at least one typology of granules of precious and/or semiprecious, natural and/or synthetic stones, to be fixed to a surface of a support, characterized by the fact of comprising the following phases:
making at least one portion of surface of the support adhesive;
distributing one typology of stone granules on the surface of the support;
pressing the stone granules on the surface of the support so that the stone granules adhere to the at least one portion of surface;
recovering the stone granules that have not adhered to the at least one portion of surface.

2. Process according to claim 1, wherein the following phases are comprised to make the at least one portion of surface of the support adhesive:
spraying a photosensitive lacquer on the support surface, made adhesive previously, so as to make the support surface no more adhesive;
exposing the at least one portion of surface of the support to UV rays so as to sensitize only the lacquer distributed on the at least one portion of surface;
removing the lacquer previously sensitized so as to make only the at least one portion of surface of the support, exposed to UV rays, adhesive again.

3. Process according to claim 2, wherein the sensitization of the lacquer distributed on the at least one portion of surface of the support takes place according to the following phases:
superimposing a mask having at least one transparent area and at least one non-transparent area on the surface of the support;
exposing the support surface covered by the mask to UV rays so that only the lacquer of the at least one portion of surface of the support corresponding to the at least one transparent area of the mask is sensitized.

4. Process according to claim 2, wherein the sensitization of the lacquer distributed on the portion of surface of the support takes place by means of a laser beam directed by an optical system on said portion of surface.

5. Process according to claim 2, wherein the removal of the sensitized lacquer takes place by immersing the surface of the support in a developing solution.

6. Process according to claim 5, wherein the developing solution is prepared with a solution containing sodium hydroxide in a quantity between 0.5% and 2% by weight.

7. Process according to claim 1, wherein the following phases are comprised to make at least one portion of the surface of the support adhesive:
applying a negative photosensitive film on the support surface made adhesive previously so as to make the support surface no more adhesive;
exposing the whole surface of the support with the exception of the at least one portion of the surface of the support, to UV rays so as to sensitize not only the film distributed on the at least one portion of the surface;
removing the previously non-sensitized film so as to make only the at least one portion of the support surface, not exposed to UV rays, adhesive again.

8. Process according to claim 1, wherein the phases of
making at least one portion of the surface of the support adhesive;
distributing one typology of stone granules on the surface of the support;
pressing the stone granules on the surface of the support so that the stone granules adhere to the at least one portion of the surface;
are carried out several times with always different typologies of stone granules so as to obtain a surface decorated with stones of different typologies.

9. Process according to claim 1, wherein the decorated surface of the support is covered with a layer of transparent resin.

10. Process according to claim 1, wherein the following additional steps are comprised, such steps being carried out after
joining the granules to a support so as to realize an initial decoration:
placing the initial decoration in the inside of a template having perimeter dimensions equal to those of the initial decoration itself so that the granules of stones of the initial decoration are facing upwards with respect to the initial support;
pouring a hardening substance in the liquid state inside the room defined by the template, on the granules of stones of the initial decoration;
making hard the hardening substance so that the granules of stones of the initial decoration fix to it;
when the hardening substance has become hard, removing the template from the manufactured article so far obtained;
removing the initial support and the adhesive substance from the manufactured article obtained so as to obtain the final decoration whose surface is provided with the granules of stones.

11. Process according to claim 10, wherein the granules of stones present on the surface of the final decoration are cleaned with a detergent or by sandblasting.

12. Process according to claim 10, wherein before pouring the hardening substance in the inside of the template, the initial decoration placed in the template is covered evenly with precious stones of very fine grain.

13. Process according to claim 10, wherein once the initial decoration has been placed in the template, after pouring a first layer of hardening substance, the template is completely filled with metal powders or sintered polymer powders.

14. Process according to claim 10, wherein photoluminescent and/or fluorescent pigments are mixed in the hardening substance.

15. Process according to claim 10, wherein a data storage and transmission device is embedded in the hardening substance.
